(19) United States
(12) Patent Application Publication
(10) Pub. No.: US 2022/0408063 A1
(43) Pub. Date: Dec. 22, 2022

(54) Stroller Camera Assembly

(71) Applicant: Ernesto Williams, Bronx, NY (US)

(72) Inventor: Ernesto Williams, Bronx, NY (US)

(21) Appl. No.: 17/351,894

(22) Filed: Jun. 18, 2021

(51) Int. Cl. H04N 7/18; H04N 5/76; H04N 5/38; H04N 5/225; B62B 9/00

(52) U.S. Cl. CPC H04N 7/183; H04N 5/76; H04N 5/38; H04N 5/2252; H04N 5/2253; B62B 9/00

(57) ABSTRACT

A stroller camera assembly includes a camera unit for recording video footage. The camera unit includes a pair of open rings that is each coupled to the camera unit. Each of the open rings can engage a structural member of a baby carriage thereby facilitating the camera unit to record footage from in front of the baby carriage. A personal electronic device is in wireless communication with the camera unit to display video footage captured by the camera unit. The personal electronic device includes an open ring that is coupled to the personal electronic device to engage a handle of the baby carriage. In this way the personal electronic device is visible to a caregiver that is pushing the baby carriage to view the video footage captured by the camera unit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to camera devices and more particularly pertains to a new camera device for capturing video footage in front of a baby carriage. The device includes a video camera that is attachable to a baby carriage and a personal electronic device that is synced with the video camera. In this way caregiver can view video footage taken from in front of the baby carriage to avoid potential hazards.

### (2) Description of Related Art Including Information Disclosed Under 37 CFR 1.97 and 1.98

The prior art relates to camera devices including a variety of video surveillance systems that are incorporated into baby carriage for monitoring the operational environment of the baby carriage. The prior art discloses a variety of alarm systems that involve wireless communication for detecting a potential threat relating to a baby carriage and alerting a caregiver to the potential threat.

### BRIEF SUMMARY OF THE INVENTION

An embodiment of the disclosure meets the needs presented above by generally comprising a camera unit for recording video footage. The camera unit includes a pair of open rings that is each coupled to the camera unit. Each of the open rings can engage a structural member of a baby carriage thereby facilitating the camera unit to record footage from in front of the baby carriage. A personal electronic device is in wireless communication with the camera unit to display video footage captured by the camera unit. The personal electronic device includes an open ring that is coupled to the personal electronic device to engage a handle of the baby carriage. In this way the personal electronic device is visible to a caregiver that is pushing the baby carriage to view the video footage captured by the camera unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a stroller camera assembly according to an embodiment of the disclosure.

FIG. 2 is a bottom view of a camera unit of an embodiment of the disclosure.

FIG. 3 is a perspective in-use view of an embodiment of the disclosure.

FIG. 4 is a top perspective in-use view of an embodiment of the disclosure.

FIG. 5 is a perspective view of an alternative embodiment of the disclosure.

FIG. 6 is a front perspective view of an alternative embodiment of the disclosure.

### DETAILED DESCRIPTION OF THE INVENTION

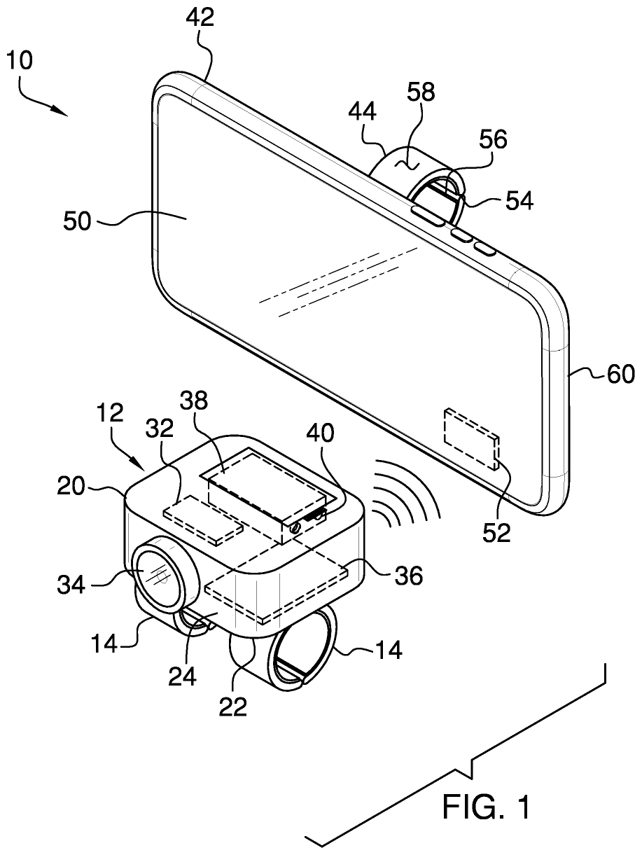

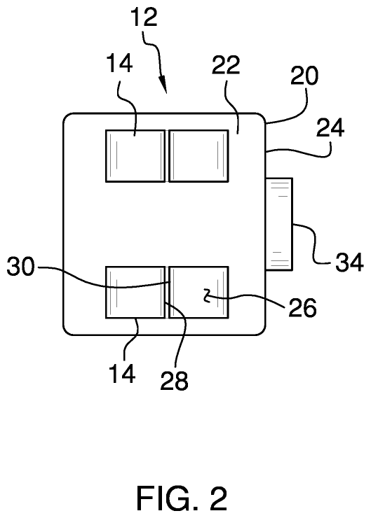

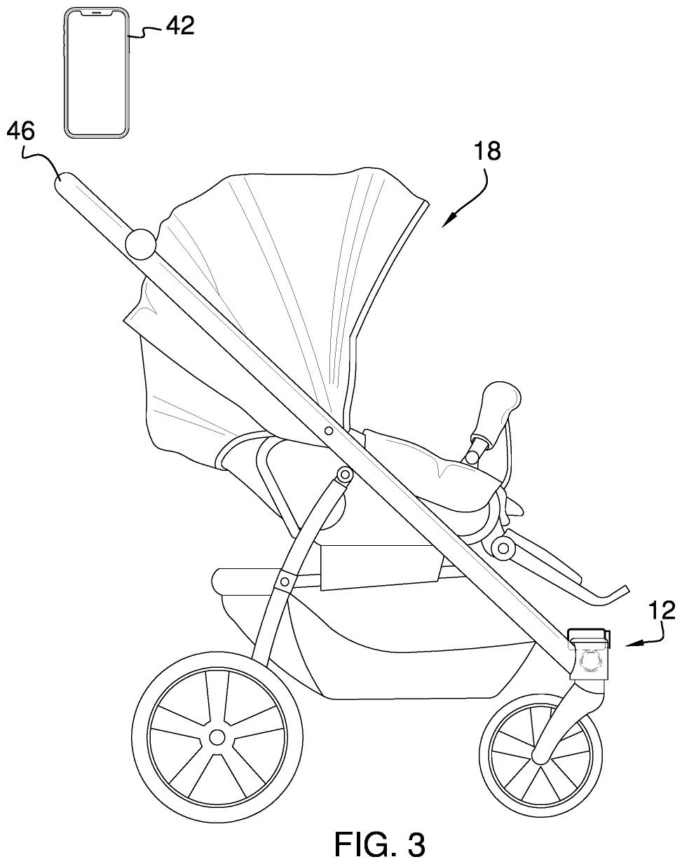

With reference now to the drawings, and in particular to FIGS. 1 through 6 thereof, a new camera device embodying the principles and concepts of an embodiment of the disclosure and generally designated by the reference numeral 10 will be described.

As best illustrated in FIGS. 1 through 6, the stroller camera assembly 10 generally comprises a camera unit 12 for recording video footage. The camera unit 12 includes a pair of open rings 14 that is each coupled to the camera unit 12 to engage a structural member 16 of a baby carriage 18. In this way the camera unit 12 can record footage from in front of the baby carriage 18. The baby carriage 18 may be stroller, for example, or any other type of carriage for transporting children. Additionally, the structural member 16 of the baby carriage 18 may be a tubular member that is commonly employed in stroller construction.

The camera unit 12 includes a housing 20 that has a bottom wall 22 and a front wall 24. An outer surface 26 of each of the open rings 14 is coupled to the bottom wall 22, and each of the open rings 14 has a first end 28 and a second end 30. Each of the open rings 14 is curved such that the first end 28 is spaced from the second end 30 on each of the open rings 14. The first end 28 can be urged away from the second end 30 to facilitate the open rings 14 to be positioned around the structural member 16. The camera unit 12 includes a control circuit 32 that is positioned in the housing 20 and a camera 34 that is integrated into the front wall 24 of the housing 20. The camera 34 is directed forwardly on the baby carriage 18 when the open rings 14 are engaged to the structural member 16. The camera 34 is electrically coupled to the control circuit 32 and the camera 34 may comprise a digital video camera or the like that has a wide angle lens.

The camera unit 12 includes a transmitter 36 that is integrated into the housing 20 and the transmitter 36 is electrically coupled to the control circuit 32. The transmitter 36 broadcasts a video signal comprising video footage captured by the camera 34. Additionally, the transmitter 36 may comprise a radio frequency transmitter or the like and the transmitter 36 may employ Bluetooth communication protocols. The camera unit 12 includes a power supply 38 that is positioned in the housing 20. The power supply 38 is electrically coupled to the control circuit 32 and the power supply 38 comprises at least one battery 40.

A personal electronic device 42 is provided and the personal electronic device 42 is in wireless communication with the camera unit 12. In this way the personal electronic device 42 can display video footage captured by the camera unit 12. The personal electronic device 42 includes an open ring 44 that is coupled to the personal electronic device 42 to engage a handle 46 of the baby carriage 18. In this way the personal electronic device 42 is visible to a caregiver 48 that is pushing the baby carriage 18 to facilitate the caregiver 48 to view the video footage captured by the camera unit 12.

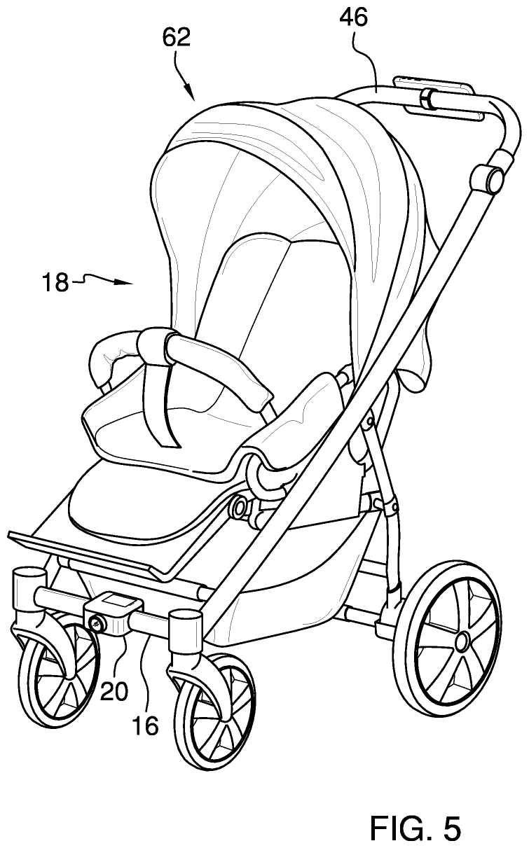

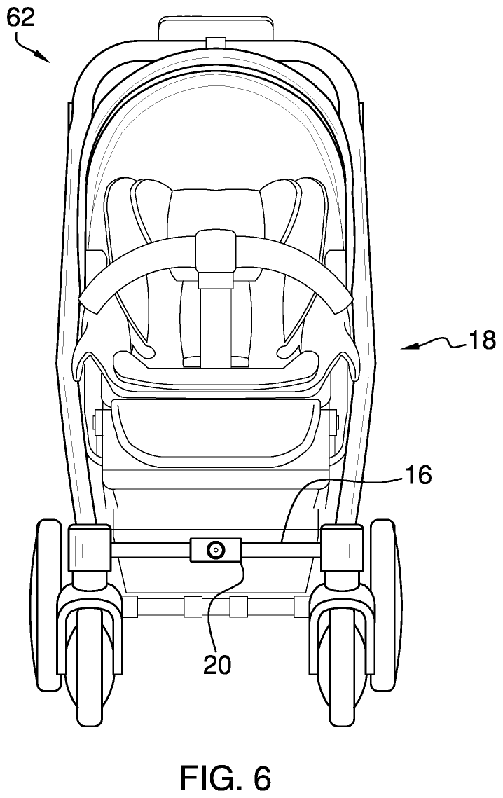

The personal electronic device 42 includes a display 50 and a receiver 52, and the receiver 52 is in wireless communication with the transmitter 36 for receiving the video signal from the transmitter 36. Additionally, the display 50 displays indicia comprising video footage from the video signal. The personal electronic device 42 may comprise a smart phone or other similar type of device that has an electronic display and wireless communication capabilities. The open ring 44 on the personal electronic device 42 has a primary end 54 and a secondary end 56. The open ring 44 on the personal electronic device 42 is curved such that the primary end 54 is spaced from the secondary end 56. An outer surface 58 of the open ring 44 on the personal electronic device 42 is coupled to a back wall 60 of the personal electronic device 42. In an alternative embodiment 62 as is most clearly shown in FIGS. 5 and 6, the housing 20 may be an integral component of the structural member 16 of the baby carriage 18.

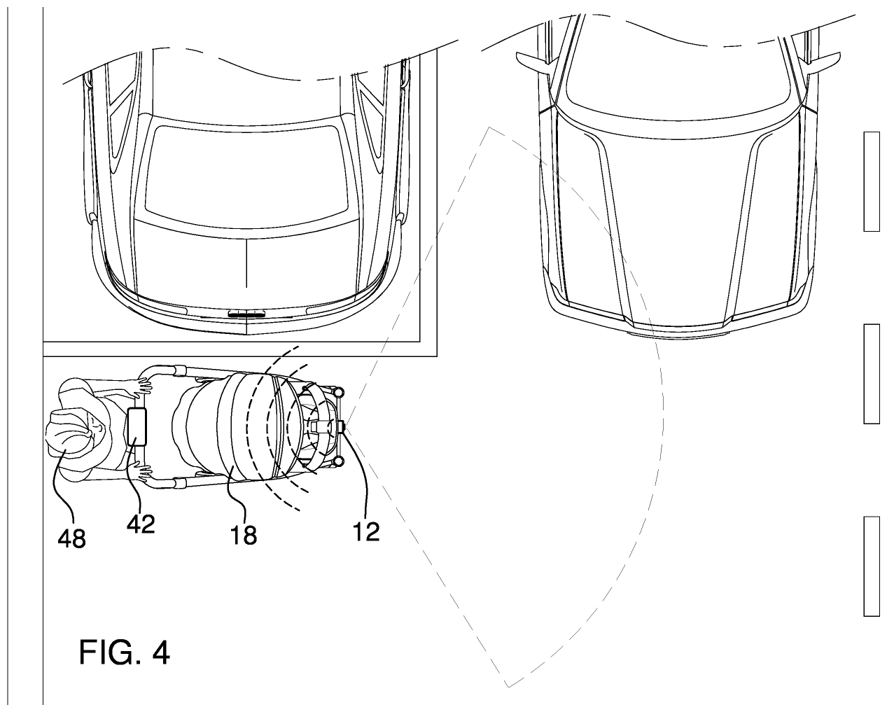

In use, the camera unit 12 is attached to the baby carriage 18 at a preferred location on the front of the baby carriage 18. The personal electronic device 42 is synchronized with the camera unit 12 to facilitate the personal electronic device 42 to receive the video footage from the camera unit 12. Additionally, the personal electronic device 42 is mounted to the handle 46 of the baby carriage 18. In this way the personal electronic device 42 displays the video footage for the caregiver 48 to view. Thus, the caregiver 48 can see a potential hazard that might be located in a blind spot for the caregiver 48. In this way, as is most clearly shown in FIG. 4, the caregiver 48 can safely push the baby carriage 18 across an intersection with multiple lanes of traffic, for example, that might expose the baby carriage 18 to the danger of being struck by an oncoming vehicle in the caregiver's 48 blind spot.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A stroller camera assembly for displaying imagery captured in front of a baby carriage thereby facilitating a caregiver to view potential hazards while pushing the baby carriage, said assembly comprising:
a camera unit for recording video footage, said camera unit including a pair of open rings each being coupled to said camera unit wherein each of said open rings is configured to engage a structural member of a baby carriage thereby facilitating said camera unit to record footage from in front of the baby carriage; and
a personal electronic device being in wireless communication with said camera unit wherein said personal electronic device is configured to display video footage captured by said camera unit, said personal electronic device including an open ring being coupled to said personal electronic device wherein said open ring on said personal electronic device is configured to engage a handle of the baby carriage wherein said personal electronic device is configured to be visible to a caregiver that is pushing the baby carriage such that the caregiver can view the video footage captured by said camera unit.

2. The assembly according to claim 1, wherein said camera unit includes:
a housing having a bottom wall and a front wall, an outer surface of each of said open rings being coupled to said bottom wall, each of said open rings having a first end and a second end, said first end being spaced from said second end on each of said open rings;
a control circuit being positioned in said housing; and
a camera being integrated into said front wall of said housing wherein said camera is configured to be directed forwardly on the baby carriage when said open rings are engaged to the structural member, said camera being electrically coupled to said control circuit.

3. The assembly according to claim 2, further comprising a transmitter being integrated into said housing, said transmitter being electrically coupled to said control circuit, said transmitter broadcasting a video signal comprising video footage captured by said camera.

4. The assembly according to claim 2, wherein:
said camera unit includes a transmitter being integrated into said housing, said transmitter being electrically coupled to said control circuit, said transmitter broadcasting a video signal comprising video footage captured by said camera; and
said personal electronic device includes a display and a receiver, said receiver being in wireless communication with said transmitter for receiving said video signal from said transmitter, said display displaying indicia comprising video footage from said video signal, said open ring on said personal electronic device having a primary end and a secondary end, said primary end being spaced from said secondary end, an outer surface of said open ring on said personal electronic device being coupled to a back wall of said personal electronic device.

5. A stroller camera assembly for displaying imagery captured in front of a baby carriage thereby facilitating a caregiver to view potential hazards while pushing the baby carriage, said assembly comprising:
a camera unit for recording video footage, said camera unit including a pair of open rings each being coupled to said camera unit wherein each of said open rings is configured to engage a structural member of a baby carriage thereby facilitating said camera unit to record footage from in front of the baby carriage, said camera unit including:
a housing having a bottom wall and a front wall, an outer surface of each of said open rings being coupled to said bottom wall, each of said open rings having a first end and a second end, said first end being spaced from said second end on each of said open rings;
a control circuit being positioned in said housing;
a camera being integrated into said front wall of said housing wherein said camera is configured to be directed forwardly on the baby carriage when said open rings are engaged to the structural member, said camera being electrically coupled to said control circuit;
a transmitter being integrated into said housing, said transmitter being electrically coupled to said control circuit, said transmitter broadcasting a video signal comprising video footage captured by said camera; and
a power supply being positioned in said housing, said power supply being electrically coupled to said control circuit, said power supply comprising at least one battery;
a personal electronic device being in wireless communication with said camera unit thereby facilitating said personal electronic device to display video footage captured by said camera unit, said personal electronic device including an open ring being coupled to said personal electronic device wherein said open ring on said personal electronic device is configured to engage a handle of the baby carriage such that said personal electronic device is visible to a caregiver that is pushing the baby carriage, wherein said personal electronic device is configured to facilitate the caregiver to view the video footage captured by said camera unit, said personal electronic device including a display and a receiver, said receiver being in wireless communication with said transmitter for receiving said video signal from said transmitter, said display displaying indicia comprising video footage from said video signal, said open ring on said personal electronic device having a primary end and a secondary end, said primary end being spaced from said secondary end, an outer surface of said open ring on said personal electronic device being coupled to a back wall of said personal electronic device.

6. The assembly according to claim 5, wherein said housing is a unitary structure with respect to the respective structural member of the baby carriage.

7. A stroller camera system for displaying imagery captured in front of a baby carriage thereby facilitating a caregiver to view potential hazards while pushing the baby carriage, said assembly comprising:
a baby carriage including a plurality of structural members and a handle;
a camera unit for recording video footage, said camera unit including a pair of open rings each being coupled to said camera unit, each of said open rings engaging a respective one of said structural members of said baby carriage thereby facilitating said camera unit to record footage from in front of said baby carriage, said camera unit including:
a housing having a bottom wall and a front wall, an outer surface of each of said open rings being coupled to said bottom wall, each of said open rings having a first end and a second end, said first end being spaced from said second end on each of said open rings;
a control circuit being positioned in said housing;
a camera being integrated into said front wall of said housing such that said camera is directed forwardly on said baby carriage when said open rings are engaged to said respective structural member, said camera being electrically coupled to said control circuit;
a transmitter being integrated into said housing, said transmitter being electrically coupled to said control circuit, said transmitter broadcasting a video signal comprising video footage captured by said camera; and
a power supply being positioned in said housing, said power supply being electrically coupled to said control circuit, said power supply comprising at least one battery;
a personal electronic device being in wireless communication with said camera unit wherein said personal electronic device is configured to display video footage captured by said camera unit, said personal electronic device including an open ring being coupled to said personal electronic device, said open ring on said personal electronic device engaging said handle of said baby carriage wherein said personal electronic device is configured to be visible to a caregiver that is pushing the baby carriage such that the caregiver can view the video footage captured by said camera unit, said personal electronic device including a display and a receiver, said receiver being in wireless communication with said transmitter for receiving said video signal from said transmitter, said display displaying indicia comprising video footage from said video signal, said open ring on said personal electronic device having a primary end and a secondary end, said primary end being spaced from said secondary end, an outer surface of said open ring on said personal electronic device being coupled to a back wall of said personal electronic device.
